(19) United States
(12) Patent Application Publication
(10) Pub. No.: US 2025/0331532 A1
(43) Pub. Date: Oct. 30, 2025

(54) CHOCOLATE PRODUCT WITH HIGH FIBRE

(71) Applicant: Kraft Foods Schweiz Holding GmbH, Zug (CH)

(72) Inventors: Teresa Ennis, Birmingham (GB); Clive Norton, East Hanover, NJ (US); Adam Harris, Birmingham (GB); Sonia J. Miguel, Reading (GB)

(21) Appl. No.: 18/870,314

(22) PCT Filed: May 30, 2023
(86) PCT No.: PCT/EP2023/025255

§ 371 Date: Nov. 27, 2024

Related U.S. Application Data
(60) Provisional application No. 63/347,535, filed on May 31, 2022.

(30) Foreign Application Priority Data
Jun. 10, 2022 (GB) 2208502.1

(51) Int. Cl. A23G 1/54; A23G 1/00; A23G 3/34; A23G 3/38; A23G 3/42; A23L 33/21

(52) U.S. Cl. CPC A23G 1/545; A23G 1/0003; A23G 3/0063; A23G 3/38; A23G 3/42; A23L 33/21

(57) ABSTRACT

The invention provides a chocolate product comprising a chocolate shell containing a confectionery filling wherein the shell comprises at least 15 wt. % of the product and wherein the filling comprises at least one soluble dietary fibre in an amount of at least 40 wt. % and wherein the filling comprises less than 5 wt. % sugar or sugars and less than 5 wt. % sugar alcohols. The invention further provides a food product having a filling comprising a chocolate product according to the invention and methods of preparing a chocolate product of the invention comprising the steps of providing a chocolate shell and providing a confectionery filling, depositing the confectionery filling into the chocolate shell and optionally sealing the chocolate shell.

### TECHNICAL FIELD OF THE INVENTION

The present invention relates to a chocolate product containing a confectionery filling and to a process for the manufacture of a chocolate product containing a confectionery filling. In particular, the invention relates to chocolate products containing a confectionery filling comprising at least one soluble dietary fibre.

### BACKGROUND TO THE INVENTION

Many chocolate and chocolate confectionery products on the market are considered energy dense foods; driven largely by sugar and fat-based ingredients necessary for the characteristic structure, taste, colour and texture.

There has been significant attention to sugar and higher energy dense foods in recent years and opportunities exist to develop lower sugar and/or energy containing chocolate products.

However, “natural” sugars (such as sucrose) are a key component in many confectionery products and provide the familiar and appealing sweetness that consumers expect from such confectionery products, together with being necessary to provide an appropriate texture and structure. Many previous attempts by confectionery manufacturers to reduce or replace sugar in confectionery products have been unsuccessful, providing an inferior taste and/or texture compared to sucrose based and/or glucose based (“full sugar”) products. Therefore, low sugar products must take into account consumer acceptance and satisfaction of texture, taste, structure and flavour.

One approach to reducing or replacing sugar in confectionery products has been to use a sugar alcohol (also known as “polyols”) instead of part or all of the sucrose and/or glucose. Sugar alcohols are less sweet than sucrose and/or glucose but generally provide fewer calories because they are incompletely digestible. As with many other incompletely digestible substances, overconsumption of sugar alcohols can lead to mild gastro-intestinal effects such as bloating, diarrhoea and flatulence. Many sugar alcohols may therefore have a recommended upper limit for daily consumption which may be exceeded by consuming excess amounts of such reduced sugar confectionery products. Another factor to consider is that some consumers may have a negative bias regarding products which are labelled as containing such “artificial sweeteners”.

However, although it has been known to reduce sugar in confectionery products, in particular chocolate, there is still difficulty in replacing sugar in confectionery fillings, such as caramel, honeycomb, jelly, nougat, fudge and marshmallow. For example, although confectionery fillings that contains no sugar can taste similar to sugar containing confectionery fillings they still do not function as well in manufacturing and do not provide the same texture and function as the “full sugar” original confectionery filling. Moreover, the primary reason for chocolate consumption is pleasure. Therefore, it is critical that the consumption experience is not compromised by a chocolate product having a reduced texture and/or taste.

Accordingly, it is an aim of the present invention to provide a chocolate product containing a confectionery filling which comprises a reduced amount of sugars and/or calories compared to a standard chocolate product.

It is also an aim of the present invention to provide a chocolate product having a confectionery filling which has a similar taste, mouthfeel profile, texture and/or function as a chocolate product comprising a sucrose-based and/or glucose-based confectionery filling.

It is also an aim of the present invention to provide a chocolate product that addresses at least one disadvantage of the prior art or to provide an alternative to existing chocolate products.

### SUMMARY OF THE INVENTION

According to a first aspect of the present invention there is provided a chocolate product comprising a chocolate shell containing a confectionery filling wherein the shell comprises at least 15 wt. % of the product and wherein the filling comprises at least one soluble dietary fibre in an amount of at least 40 wt. % and wherein the filling comprises less than 35 wt. % sugar or sugars.

The inventors discovered that a chocolate product comprising a very low sugar confectionery filling comprising at least one soluble dietary fibre in an amount of at least 40 wt. % was able to reduce the amount of sugars and calories compared to a chocolate product comprising a sucrose-based and/or glucose-based (“full sugar”) standard confectionery filling with a substantial chocolate shell whilst still delivering the same taste, texture and/or indulgence experience. Moreover, the confectionery filling contains a reduced amount of sugars and calories in the chocolate product, whilst still providing the same manufacturing qualities, taste, texture and function as a “full sugar” standard confectionery filling. Moreover, the products are able to advantageously increase daily intake of dietary fibre by the consumer.

By “sugar” it is meant a monosaccharide or disaccharide with an energy content of >3 kcal/g. Examples of sugars included within the term are glucose, fructose, galactose, sucrose, lactose, maltose, isomaltose and sugar hydrates (such as dextrose monohydrate, for example), among others.

The term ‘chocolate’ includes any material that meets a legal definition of chocolate in any jurisdiction. However, the term ‘chocolate’ is not limited to material which meets any legal definition of chocolate and also includes chocolate substitutes and analogues. For instance, ‘chocolate’ herein includes materials in which all or part of the cocoa butter (CB) of legally or regulatory-defined chocolate is replaced by cocoa butter equivalents (CBE), cocoa butter substitutes (CBS), cocoa butter replacers (CBR) and/or other lipids. For example, the term “chocolate” also includes chocolates in which part, or all the cocoa butter has been replaced by vegetable fat. The term ‘compound chocolate’ as used herein means chocolate-like analogues characterized by presence of one or more cocoa solids from any part of the cocoa bean or cocoa pod (which may be one or more selected from the group consisting of cocoa mass, cocoa butter, cocoa powder, cocoa pulp, cocoa husk and cocoa shell,) in any amount.

The term ‘cocoa’, as used in any context throughout this specification, is also taken to include the tautologous terminology ‘cacao’.

By “soluble dietary fibre” it is meant a plant-based or plant-derived carbohydrate, animal-based or animal derived fibre such as milk fibres, or a synthetic carbohydrate such as polydextrose, that is not digested in the small intestine, and is soluble in water. Soluble dietary fibres are differentiated from insoluble dietary fibres which are not soluble in water, are generally metabolically inert and provide bulking in the intestinal tract. The amount of soluble dietary fibre can be measured by Official method of analysis, AOAC INTERNATIONAL. Methods 2009.

The at least one soluble dietary fibre may be selected from the group consisting of inulin, fructooligosaccharide (FOS), isomaltose oligosaccharide (IMO), polydextrose, maltodextrin, vegetable-derived fibres, plant-derived fibres, galacto-oligosaccharide (GOS), levan, phlein, graminin, neo-levan, neo-inulin, hemicellulose, xylans, arabinoxylan, milk oligosaccharides, milk fibres, cellodextrins such as cellobiose and cellotriose, polydextrose, kestose, nystose, raffinose, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, 2′-fucosyl lactose, lacto-n-neotetraose, glucan (i.e., glucose containing) oligosaccharides, cello-oligosaccharides (or cellodextrins), resistant dextrins (e.g., soluble corn fibre, soluble pea fibre, soluble wheat fibre, soluble tapioca fibre), nigero-oligosaccharides, nigerotriose, nigerotetraose, kojitriose, kojitetraose, dextrans, beta glucans, lichenan, and isolichenan and combinations thereof, among others.

The confectionery filling comprises at least 40 wt. % soluble dietary fibre, or at least 42, 44, 45, 46, 48, 50, 52, 54, 55, 56, 58, 60, 62, 64, 65, 66, 68, 70 71, 72, 73, 74, 75, 76, 77, 78, 79, 80, 81, 82, 83, 84, 85, 86, 87, 88, 89, or at least 90 wt. % soluble dietary fibre. In some embodiments, the product comprises less than 92 wt. % soluble dietary fibre, or less than 91, 90, 89, 88, 87, 86, 85, 84, 82, 80, 78, 76, 75, 74, 72, 70, 68, 66, 65, 64, 62, 60, 58, 56, 55, 54, 52 or less than 50 wt. % soluble dietary fibre. In some embodiments, the confectionery filling may comprise 40-92 wt. % soluble dietary fibre, or 40-92, 42-92, 44-92, 45-92, 46-92, 48-92, 50-92, 52-92, 54-92, 55-92, 56-92, 58-92, 60-92, 40-92, 40-91, 40-90, 40-89, 40-88, 40-87, 40-86, or 40-85 wt. %. In some embodiments the confectionery filling may comprise 71-85 wt. % soluble dietary fibre, or 42-85, 44-85, 46-85, 48-85, 50-85, 52-85, 55-85, 56-85 or 60-85 wt. % soluble dietary fibre.

The confectionery filling may comprise 1, 2 3, 4, 5, 6, 7, 8, 9, or 10 different soluble dietary fibres. The confectionery filling may comprise a plurality of different soluble dietary fibres. The confectionery filling may comprise a blend of soluble dietary fibres.

In one embodiment, the confectionery filling composition may comprise at least one fructan and at least one further soluble dietary fibre in a total amount of at least 40 wt. % of the confectionery filling.

By the term “fructan” it is meant a polymer of fructose molecules having one or more fructosyl residues linked by β-2,1-linkages and/or β-2,6-linkages, and having a terminal sugar moiety such as glucose.

The at least one fructan may be selected from the group consisting of inulin, fructooligosaccharide (FOS), levan, phlein, graminin, neo-levan, neo-inulin and combinations thereof. Preferred fructans are inulin and FOS.

In one embodiment, the confectionery filling may comprise at least one fructan; at least one IMO; and at least one further soluble dietary fibre.

The confectionery filling may comprise at least one fructan selected from the group consisting of inulin, FOS, levan, phlein, graminin, neo-levan, neo-inulin and combinations thereof in an amount (or a combined amount if more than one ingredient is selected such as both inulin and an FOS, for example) of from 2-85 wt. % of the confectionery filling or 4-85, 6-85, 8-85, 10-85, 12-85, 14-85, 16-85, 18-85, 20-85, 22-85, 24-85, 26-85, 28-85, 30-85, 2-84, 2-82, 2-80, 2-78, 2-76, 2-74, 2-72, 2-70, 2-68, 2-66, 2-64, 2-62, 2-60, 2-58, 2-56, 2-54, 2-52, 2-50, 2-48, 2-46, 2-44, 2-42, 2-40, 2-38, 2-36, 2-35, 2-34, 2-32, 2-30, 2-28, 2-26, 2-24, 2-22, 2-20, 2-85, 4-84, 6-82, 8-80, 10-78, 10-76, 10-74, 10-72, 10-70, 10-68, 10-66, 10-64, 10-62, 10-60, 10-58, 10-56, 10-54, 10-52, 10-50, 10-48, 10-46, 10-44, 10-42, 10-40, 10-38, 10-36, 10-35, 12-35, 14-35, 16-35, 18-35, or 20-35 wt. % of the confectionery filling. Preferably, the confectionery filling comprises at least one fructan in an amount (or total amount) of 10-35 wt. % of the confectionery filling.

The confectionery filling may comprise IMO in an amount of from 2-72 wt. % of the confectionery filling or 4-72, 6-72, 8-72, 10-72, 12-72, 14-72, 16-72, 18-72, 20-72, 22-72, 24-72, 26-72, 28-72, 30-72, 2-70, 2-68, 2-66, 2-66, 2-64, 2-62, 2-60, 2-58, 2-56, 2-54, 2-52, 2-50, 2-48, 2-46, 2-44, 2-42, 2-40, 2-38, 2-36, 2-35, 2-34, 2-32, 2-30, 2-28, 2-26, 2-24, 2-22, 2-20, 2-72, 4-70, 6-68, 8-66, 10-64, 12-62, 14-60, 16-58, 18-56, 20-54, 22-52, 24-50, 25-48, 25-46, 25-44, 25-42, 25-40, 25-38, 25-36, 25-35, 26-35, 28-35, or 30-35 wt. % of the confectionery filling. Preferably, the confectionery filling may comprise IMO in an amount of 25-35 wt. % of the confectionery filling.

The confectionery filling may comprise at least one further soluble dietary fibre selected from the group consisting of polydextrose, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, milk oligosaccharides, 2′-fucosyl lactose, lacto-n-neotetraose, glucan (i.e., glucose containing) oligosaccharides, cello-oligosaccharides (or cellodextrins), resistant dextrins (e.g., soluble corn fibre, soluble wheat fibre, soluble tapioca fibre, soluble pea fibre), nigero-oligosaccharides, nigerotriose, nigerotetraose, kojitriose, kojitetraose, dextrans, beta glucans, lichenan, isolichenan, and combinations thereof in an amount (or total amount) of from 2-72 wt. % of the confectionery filling or 4-72, 6-72, 8-72, 10-72, 12-72, 14-72, 16-72, 18-72, 20-72, 22-72, 24-72, 26-72, 28-72, 30-72, 2-70, 2-68, 2-66, 2-66, 2-64, 2-62, 2-60, 2-58, 2-56, 2-54, 2-52, 2-50, 2-48, 2-46, 2-45, 2-44, 2-42, 2-40, 2-38, 2-36, 2-35, 2-72, 4-70, 6-68, 8-66, 10-64, 10-62, 10-60, 10-58, 10-56, 10-54, 10-52, 10-50, 10-48, 10-46, 10-45, 12-45, 14-45, 16-45, 18-45, or 20-45 wt. % of the confectionery filling. Preferably, the confectionery filling may comprise at least one further soluble dietary fibre selected from the group consisting of polydextrose, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, milk oligosaccharides, 2′-fucosyl lactose, lacto-n-neotetraose, glucan (i.e., glucose containing) oligosaccharides, cello-oligosaccharides (or cellodextrins), resistant dextrins (e.g., soluble corn fibre, soluble wheat fibre, soluble tapioca fibre, soluble pea fibre), nigero-oligosaccharides, nigerotriose, nigerotetraose, kojitriose, kojitetraose, dextrans, beta glucans, lichenan, isolichenan, and combinations thereof in an amount (or total amount) of 10-45 wt. % of the confectionery filling.

In a preferred embodiment of the present invention, the confectionery filling comprises at least one fructan selected from the group consisting of inulin, FOS, and combinations thereof in an amount (or total amount) of from 2-72 wt. % of the confectionery filling; IMO in an amount of from 2-60 wt. % of the confectionery filling; and at least one further soluble dietary fibre selected from the group consisting of polydextrose, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, milk oligosaccharides, 2′-fucosyl lactose, lacto-n-neotetraose, glucan (i.e., glucose containing) oligosaccharides, cello-oligosaccharides (or cellodextrins), resistant dextrins (e.g., soluble corn fiber, soluble wheat fibre, soluble tapioca fibre, soluble pea fibre), nigero-oligosaccharides, nigerotriose, nigerotetraose, kojitriose, kojitetraose, dextrans, beta glucans, lichenan, isolichenan, and combinations thereof in an amount (or total amount) of from 2-50 wt. % of the confectionery filling.

More preferably, the confectionery filling comprises at least one fructan selected from the group consisting of inulin, FOS, and combinations thereof in an amount (or total amount) of from 10-35 wt. % of the confectionery filling; IMO in an amount of from 25-35 wt. % of the confectionery filling; and at least one further soluble dietary fibre selected from the group consisting of polydextrose, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, milk oligosaccharides, 2′-fucosyl lactose, lacto-n-neotetraose, glucan (i.e., glucose containing) oligosaccharides, cello-oligosaccharides (or cellodextrins), resistant dextrins (e.g., soluble corn fibre, soluble wheat fibre, soluble tapioca fibre, soluble pea fibre), nigero-oligosaccharides, nigerotriose, nigerotetraose, kojitriose, kojitetraose, dextrans, beta glucans, lichenan, isolichenan, and combinations thereof in an amount (or total amount) of from 10-45 wt. % of the confectionery filling.

The confectionery filling may comprise less than 34, 32, 30, 28, 26, 25, 24, 23, 22, 21, 20, 18, 16, 15, 14, 12, 10, 8, 6, 5, 4, 3, 2, 1, 0.5, 0.1, or less than 0.01 wt. % sugar or sugars. In some embodiments, the confectionery filling is essentially free of or free of sugar or sugars. In some embodiments, the confectionery filling comprises no sugar or sugars.

The confectionery filling may comprise less than 10, 5, 4, 3, 2, 1, 0.5, 0.1, or less than 0.01 wt. % sucrose. In some embodiments, the confectionery filling may be essentially free of or free of sucrose.

In some embodiments the confectionery filling may comprise less than 10, 5, 4, 3, 2, 1 or 0.5 wt. % glucose, and comprise substantially no glucose or no glucose.

In one embodiment, the confectionery filling may comprise less than 5 wt. % sugar or sugars and less than 5 wt. % sugar alcohols.

In such an embodiment, there is provided a chocolate product comprising a chocolate shell containing a confectionery filling wherein the shell comprises at least 15 wt. % of the product and wherein the filling comprises at least one soluble dietary fibre in an amount of at least 40 wt. % and wherein the filling comprises less than 5 wt. % sugar or sugars and less than 5 wt. % sugar alcohols.

The confectionery filling may be in the form of a caramel, nougat, marshmallow, fudge jelly or honeycomb. In one embodiment, the confectionery filling may be a centre of a chocolate product.

The confectionery filling may comprise one or more further ingredients. The one or more further ingredients may be selected from the group consisting of egg powder, foaming agents, milk powder, hydrocolloid s (such as pectin, carrageen, gum Arabic, xanthan, modify starch, resistant starch and/or gelatine), emulsifier, fat, oil, thickener, preservative, water, acids, pH buffers, colours and flavours, and combinations thereof.

The confectionery filling may comprise nougat, and may comprise in addition to the at least one soluble dietary fibre; one or more ingredients selected from the group comprising: egg powder, egg albumin, foaming agents, hydrocolloids (such as pectin, carrageen, gum Arabic, xanthan, modify starch, resistant starch and/or gelatine), thickener, preservative, water, acid, colours and flavours, and combinations thereof.

The confectionery filling may comprise fudge, and may comprise in addition to the at least one soluble dietary fibre; one or more ingredients selected from the group comprising: fat, oil, emulsifiers, milk powders, thickener, preservative, water, colours and flavours, and combinations thereof.

The confectionery filling may comprise marshmallow, and may comprise in addition to the at least one further soluble dietary fibre; one or more ingredients selected from the group comprising: egg powder, egg albumin, foaming agents, hydrocolloids (such as pectin, carrageen, gum Arabic, xanthan, modify starch, resistant starch and/or gelatine), thickener, preservative, water, acid, colours and flavours, and combinations thereof.

The confectionery filling may comprise honeycomb, and may comprise in addition to the at least one soluble dietary fibre; one or more ingredients selected from the group comprising: egg powder, egg albumin, foaming agents, hydrocolloids (such as pectin, carrageen, gum Arabic, xanthan, modify starch, resistant starch and/or gelatine), thickener, preservative, water, colours and flavours, and combinations thereof.

The confectionery filling may comprise jelly confectionery, and may comprise in addition to the at least one further soluble dietary fibre; one or more ingredients selected from the group comprising: hydrocolloids (such as pectin, carrageen, gum Arabic, xanthan, modify starch, resistant starch and/or gelatine), thickener, preservative, water, acids, colours and flavours, and combinations thereof.

The confectionery filling may comprise caramel, and may comprise in addition to the at least one soluble dietary fibre; one or more ingredients selected from the group comprising: fat, oil, emulsifiers, milk powders, thickener, preservative, water, colours and flavours, and combinations thereof.

The confectionery filling may comprise a sweetener.

The sweetener may be an artificial sweetener and/or natural sweetener.

Artificial sweeteners may be selected from the group comprising: acesulfame K, advantame, alitame, aspartame, aspartame-acesulfame salt, cyclomates, glucin, neohespiridin dihydrochalcone, neotame, saccharin, sucralose, rebaudioside A, rebaudioside D, rebaudioside M and combinations thereof.

Natural sweeteners may be selected from the group comprising: glycyrrhizin, monatin, osladine, stevia, steviol glycosides, monk fruit, mogrosides, and combinations thereof.

The confectionery filling may comprise less than 10 wt. % of sugar alcohols, preferably less than 9, 8, 7, 6, 5, 4, 3, 2, 1, 0.5 or less than 0.1 wt. % sugar alcohols. In some embodiments the confectionery filling is essentially free from sugar alcohols or does not comprise sugar alcohols.

Advantageously, the reduction of the amount of sugar alcohols in the confectionery filling reduces any potential laxative problems of the chocolate product.

By “sugar alcohol” it is meant a sugar alcohol with an energy of 0-4.5 kcal/g. Examples of sugar alcohols included within the term are erythritol, maltitol, mannitol, sorbitol, xylitol, arabitol, sorbitol, glycerol, hydrogenated starch hydrosylates (HSH), isomalt and lactitol.

The confectionery filling may be essentially free of or free of low energy sugar.

By “low energy sugar” it is meant a sugar having an energy content of less than 2 kcal/g. Examples of low energy sugars included within the term are tagatose, sorbose, cellobiose, xylose, altrose, L-glucose and psicose.

The confectionery filling may comprise at least 75 wt. % of the product, or at least 76, 77, 78, 79 or 80 wt. % of the product. The confectionery filling may comprise up to 85 wt. % of the product, or up to 84, 83, 82, 81, 80 wt. % of the product. The chocolate shell may comprise 75-85 wt. % of the product, or 76-85, 77-85, 78-85, 79-85, 80-85, 75-84, 75-83, 75-82, 75-81, or 75-80 wt. % of the product.

The chocolate product may comprise up to35 wt. % total sugars, up to 34 wt. %, up to 33 wt. %, up to 32 wt. %, up to 31 wt. %, up to 30 wt. %, up to 29 wt. %, up to 28 wt. %, up to 27 wt. %, up to 26 wt. %, up to 25 wt. %, up to 24 wt. %, up to 22 wt. %, up to 20 wt. %, up to 19 wt. %, up to 18 wt. %, up to 17 wt. %, up to 15 wt. % total sugars.

The chocolate product may comprise at least 10 wt. % total sugars, suitably at least 12 wt. %, suitably at least 14 wt. %, suitably at least 16 wt. %, at least 18 wt. %, or at least 20 wt. % total sugars.

The chocolate product may comprise from 5 to 35 wt. % total sugars, from 6 to 35 wt. %, from 8 to 35 wt. %, from 10 to 35 wt. %, from 12 to 35 wt. %, from 14 to 35 wt. %, 15 to 35 wt. %, 15 to 30 wt. %, 15 to 25 wt. % total sugars.

It should be understood that some or all of the total sugars may be present in the chocolate shell, in order for the product to achieve total sugars of up to 35 wt. % of the chocolate product. The chocolate shell may comprise at least 50% of the total sugars in the chocolate product, at least 60%, at least 70%, at least 80%, at least 85%, at least 90%. In some embodiments the chocolate shell may comprise no more than 99%, 98%, 97%, 96%, 95%, 94%, 93%, 92%, or 91% of the total sugars in the chocolate product.

The chocolate shell may comprise 50 to 100%, 60 to 100%, 70 to 100%, 80 to 100%, 80 to 95%, 85 to 95%, 80 to 90%, 80 to 85%, 85 to 90% of the total sugars in the chocolate product.

The total sugars of the chocolate product of the first aspect may be reduced by at least 10% compared to a known reference “full sugar” chocolate product, suitably reduced by at least 15%, suitably at least 20%, suitably at least 25%, suitably at least 28% or at least 30%. In some embodiments the total sugars of the chocolate product may be reduced by at least 40%, for example at least 45%, at least 50%, at least 55%, at least 60%, at least 65%, at least 70%. In some embodiments the total sugars of the chocolate product of the first aspect may be reduced by up to 75%, up to 70%, up to 65%, up to 60%, up to 55%, up to 50% when compared to a known reference “full sugar” chocolate product. The total sugars may be reduced whilst retaining the taste and texture of a “full sugar” chocolate comprising a confectionery filling.

The chocolate shell may comprise at least 16 wt. % of the product, or at least 17, 18, 19, or 20 wt. % of the product. The chocolate shell may comprise up to 25 wt. % of the product, or up to 24, 23, 22, 21, 20 wt. % of the product. The chocolate shell may comprise 15-25 wt. % of the product, or 16-25, 17-25, 18-25, 19-25, 20-25, 15-24, 15-23, 15-22, 15-21, or 15-20 wt. % of the product.

The chocolate shell may comprise up to 35 wt. % of cocoa ingredients, such as cocoa mass, cocoa butter, cocoa powder, cocoa pulp, cocoa husk and cocoa shell. The chocolate shell may comprise suitably 32 wt. %, for example up to 30 wt. % of cocoa ingredients. The chocolate shell may comprise from 15 to 35 wt. % of cocoa ingredients, suitably from 20 to 30 wt. %, for example from 25 to 30 wt. % of cocoa ingredients.

The chocolate product may comprise at least 1 wt. % of total fat, or at least 2 wt. %, or at least 3 wt. % of total fat. The chocolate product may comprise up to 5 wt. %

of total fat, or up to 4 wt. %, or up to 3 wt. % of total fat. The chocolate product may comprise from 1 to 5 wt. % of total fat, or 1 to 4 wt. %, 1 to 3 wt. %, 1 to 2 wt. %, 2 to 5wt. %, 3 to 5 wt. %, or 4 to 5wt. % of total fat.

The confectionery filling may be partially or fully surrounded by the chocolate shell. An outer surface of the confectionery filling may be at least 50% surrounded by the chocolate shell, or at least 60, 70, 80, or at least 90%, or substantially 100% of the outer surface area of the confectionery filling may be surrounded by the chocolate shell. The chocolate shell may form a layer of even or uneven thickness. In some embodiments, the layer has a thickness of at least 1, 2, 3, 4, or at least 5 mm. The layer may have a thickness of no greater than 20 mm, 15 mm or no greater than 10 mm. The thickness may be determined by measuring the depth of chocolate from the surface of the centre of the confectionery filling to the outer surface of the chocolate shell by a standard measuring tool, such as a calliper.

In some embodiments, the chocolate product is a confectionery filling coated or enrobed with a chocolate shell. The chocolate shell may comprise a layer of coating material on a surface of the confectionery filling, preferably an outer surface. The chocolate shell may comprise a layer of coating material over at least 50% of the outer surface area of the confectionery filling, or over at least 60, 70, 80, 90%, or over substantially 100% of the outer surface area of the confectionery filling.

The chocolate product may be a non-milk or low milk containing (commonly referred to as plain and/or dark), milk, compound, or white chocolate product. Preferably, the product is a plain, dark or milk chocolate product.

In some embodiments, the chocolate shell may assume any shape, such as an egg, animal, star, Santa, lentil, bean, lozenge, cuboid, sphere etc.

The chocolate product may comprise a tablet or block of chocolate and may comprise multiple portions of chocolate shell and confectionery filling, connected via break lines or regions, for example.

In some embodiments, the inventive chocolate product is a filling within an edible food product.

Therefore, another aspect of the invention is therefore a food product having a filling comprising the chocolate product of the first aspect of the invention. In some embodiments the filling consists of, or consists essentially of, the chocolate product. The food product may be a chocolate product or a non-chocolate product. The food product may be a farinaceous product, or a baked farinaceous product. The food product may include but is not limited to baked products such as cakes, doughnuts, wafers, pastries, tarts, etc. The food product may be a confectionery product such as hard candy, jelly candy, chewy candy, toffee, fudge, marshmallow etc., that contains a chocolate product centre. The chocolate product may be partially or fully surrounded by the food product. The outer surface area of the chocolate product may be at least 50% surrounded by the food product, or at least 60, 70, 80, or at least 90%, or substantially 100% of the outer surface area of the chocolate product may be surrounded by the food product. The food product may form a layer of even or uneven thickness. In some embodiments, the layer has a thickness of at least 1, 2, 3, 4, or at least 5 mm. The layer may have a thickness of no greater than 10, 9, 8, 7, 6, or no greater than 5 cm.

In some embodiments, the chocolate product is a coated or enrobed chocolate product. The chocolate product may comprise a layer of coating material on a surface of the chocolate product, preferably an outer surface. The chocolate product may comprise a layer of coating material over at least 50% of the outer surface area of the chocolate product, or over at least 60, 70, 80, 90%, or over substantially 100% of the outer surface area of the chocolate product. The coating material may comprise a non-chocolate confectionery material. The coating material may include but is not limited to one or more coating materials selected from the group comprising: frosting; candy; honey; caramel; toffee; fondant; cream; mousse; gel; jam; sugar; sugar alcohol; syrup; and combinations thereof.

Statements of invention relating to the chocolate product of the first aspect of the invention may also be applied to the second aspect of the invention.

According to a third aspect of the present invention, there is provided a packaged chocolate product according to a first aspect of the present invention. Statements of invention relating to the chocolate product of the first aspect of the invention may also be applied to the fourth aspect of the invention.

The chocolate product may be packaged in any suitable packaging material, which may in some embodiments be any one or more materials independently selected from the group comprising cardboard, paper, paperboard, flow-wrap plastics, metal foil, plastics foil and combinations and laminates thereof.

Suitable packaging for the chocolate product may be reclosable or not reclosable (or resealable or not resealable) as known to a person skilled in the art.

The chocolate product may be provided in a form and size intended for a single serving.

A single serving may have a weight in the range of from 10 g to 200 g.

In some embodiments the chocolate product may be provided in a form and size intended to provide multiple servings. The multiple serving of the chocolate product may have a weight greater than 30 g, 40 g, 50 g, 60 g, 70 g, 80 g, 90 g, 100 g, 250 g or greater than 500 g. The multiple serving of the chocolate product may comprise a single body. The single body of chocolate product may have defined portions intended to be broken or torn off the body of the chocolate product to provide a serving of the product. A suitable form of the one body of the chocolate product may be a tablet, block, or bar.

In some embodiments, a multiple serving of the chocolate product may be provided as individual pieces. Suitably, the bite-size pieces may have a weight in the range of from 1 g to 30 g. The bite-size pieces may be individually wrapped. Alternatively, the bite-size pieces may not be individually wrapped. A plurality of bite-size pieces may be contained in a suitable container. The container may be reclosable and/or resealable.

According to a fourth aspect of the invention, there is provided a method of preparing the chocolate product of the first aspect of the invention, the method comprising the steps of providing a chocolate shell and providing a confectionery filling, depositing the confectionery filling into the chocolate shell and optionally sealing the chocolate shell.

Chocolate shells of any suitable shape may be provided, such as eggs, animals, stars, Santa, etc.

In some embodiments, the chocolate shell is provided as two complementary fitting sections. The complementary fitting sections of the shell may be attachable to each other to provide a sealed chocolate shell defining an internal cavity capable of containing the filling. At least one or both complementary fitting sections of the shell may define their own cavity into which a filling may be independently deposited before attaching the sections to each other to provide the sealed chocolate shell. The filling in each section may be the same or different. In some embodiments, only one of the two complementary fitting sections of the shell defines its own cavity, and the other section is in the form of a flat or substantially flat chocolate backing.

In some embodiments, the step of providing the chocolate shell comprises forming a first section of the shell in a mould cavity. In such embodiments, the first section defines a cavity in the shape of the mould cavity and into which the filling may be deposited. Moulds may preferably be selected to match the shapes and/or sizes of the chocolate product as detailed in the first aspect of the invention. The step of sealing the chocolate shell may comprise applying a chocolate backing over the first section of the shell and over the filling contained in the first section to seal the shell with the filling enclosed within.

The step of sealing the chocolate shell by attaching two complementary fitting sections of the shell to each other may employ any suitable method known to those skilled in the art. Examples of suitable methods include but are not limited to gluing the sections to each other using an edible glue or applying heat to the points of contact of the two sections to facilitate sealing.

Alternatively, the method may comprise the steps of providing a chocolate shell and providing a confectionery filling, and coating the confectionery filling with the chocolate shell.

Any suitable method of coating known to those skilled in the art may be employed. Such a method may provide a layer of the chocolate shell on a surface of the confectionery filling. The surface may comprise an outer surface of the confectionery filling. The method may comprise coating a layer of the chocolate shell on at least 50% of the outer surface area of the confectionery filling, or on at least 60, 70, 80, 90%, or on substantially 100% of the outer surface area of the confectionery filling.

In some embodiments, the step of coating may comprise enrobing the confectionery filling with the chocolate shell. The method may comprise passing the confectionery filling through a curtain or stream of the chocolate shell. The curtain or stream may be formed by a molten chocolate shell falling from an elevated position relative to the edible product. The molten chocolate shell may fall from an elevated trough or like device fed from a suitable container.

In some embodiments, the step of coating may comprise dipping the confectionery filling into a chocolate shell. Suitable methods of dipping include hand-dipping and dipping the edible product using suitable machinery known in the art.

In some embodiments, the step of coating may comprise pan coating the confectionery filling with the chocolate shell. Pan coating is known to those skilled in the art and makes use of rotating drums to coat the confectionery filling with a chocolate shell coating. The pan coating method may include but is not limited to one or more of: spray pan coating, ladling, and drip-feeding.

The method may further comprise a step of moulding or extruding the chocolate product to form a bar or block, after filling the chocolate shell. Preferably, the method may comprise moulding the chocolate product to form a solid bar or block.

The method may include any one or more of size-reducing, refining, conching, tempering and pasting the chocolate product, or ingredients thereof, as is customary in the art of chocolate-making.

The method may comprise packaging the chocolate product to produce the packaged chocolate product of the fourth aspect of the invention.

According to another aspect of the invention there is provided a method of providing a filled or coated food product, in which a food product is filled or coated with a chocolate product of the first aspect of the invention.

In some embodiments, the inventive chocolate product is applied to a food product as a coating. In some embodiments, the chocolate product is applied as a molten coating and solidified. The food product may be a chocolate product or non-chocolate product. Food products include but are not limited to those listed for the second aspect of the invention.

Any suitable method of coating known to those skilled in the art may be employed. Such a method may provide a layer of the inventive chocolate product on a surface of the food product. The surface may comprise an outer surface of the food product. The method may comprise coating a layer of the inventive chocolate product on at least 50% of the outer surface area of the food product, or on at least 60, 70, 80, 90%, or on substantially 100% of the outer surface area of the food product.

In some embodiments, the method comprises enrobing the food product with the inventive chocolate product. The method may comprise passing the food product through a curtain or stream of the inventive chocolate product. The curtain or stream may be formed by molten inventive chocolate product falling from an elevated position relative to the food product. The molten inventive chocolate product may fall from an elevated trough or like device fed from a suitable container.

In some embodiments, the method comprises dipping the food product into the molten inventive chocolate product. Suitable methods of dipping include hand-dipping and dipping the food product using suitable machinery known in the art.

In some embodiments, the method comprises pan coating the food product with the inventive chocolate product. Pan coating is known to those skilled in the art and makes use of rotating drums to coat the food product with a chocolate coating. The pan coating method may include but is not limited to one or more of: spray pan coating, ladling, and drip-feeding.

In some embodiments, the method comprises filling a food product with the prepared inventive chocolate product. Any suitable method of filling known to those skilled in the art may be employed. The food product may include but is not limited to the food products described in the first aspect of the invention, especially confectionery and farinaceous or baked products. The food product may be provided in the form of one or more shells, as described hereinabove for embodiments in which the chocolate product is provided as one or more shells. In some embodiments, the chocolate product, in molten or paste form, may be extruded, injected, or otherwise deposited into a cavity formed in the food product, and optionally solidified thereafter.

The filled or coated food product may be packaged, as described hereinabove for other aspects of the invention.

The further aspects of the present invention may incorporate any of the features of the other aspects of the invention described herein as desired or as appropriate.

### DETAILED DESCRIPTION OF THE INVENTION

In order that the invention may be more clearly understood one or more embodiments thereof will now be described, by way of example only:

### Inventive Chocolate Products

The following chocolate products of the invention were prepared. The confectionery fillings were mixed using standard chocolate and filling making techniques and were enrobed in a chocolate shell by feeding the confectionery fillings through a melted chocolate curtain and solidifying.

All prepared chocolate products were rectangular and/or square confectionery filling centres enrobed in a chocolate shell at room temperature and ambient pressure. The confectionery fillings were able to provide chocolate products that were low in saturated fat, sugar, and energy (calories). The products provided a similar taste, mouthfeel profile texture and function as a chocolate product comprising a sucrose-based and/or glucose-based confectionery filling, together with good rigidity.

The confectionery filling was able to reduce the amount of sugars and calories in the chocolate product whilst still providing equivalent manufacturing qualities, texture and function to “full sugar” or sucrose-based and/or glucose-based chocolate products (e.g. those with large quantities of sucrose, glucose or large quantities of high energy mono- or disaccharides).

### Example 1: Chocolate Product Having a Caramel Confectionery Filling

The ingredients for the caramel confectionery filling are detailed in Table 1 below.

TABLE 1

| | Wet Weight | % soluble |
|---|---|---|
| | % of | dietary fibre |
| | ingredient in | of |
| Ingredient | filling | ingredient |
| Water | −6.1 | — |
| canola oil | 4 | — |
| soya lecithin | 0.03 | — |
| Inulin (Orafti ® HIS/Orafti ® L90/Fructulose) | 14.7 | 85-90 |
| IMO (DP3 Vitafiber ™/IMO Vitafiber ™/IMO | 38 | 60-90 |
| HDP Oligosmart ®/IMO OligoSmart ®) | | |
| Soluble fibre-liquidcorn (PROMITOR ® 85NL, | 21 | 70-95 |
| Tate & Lyle/Promitor ® L70/Promitor ® 85/ | | |
| Nutriose ® 06/Nutriose ® 10) | | |
| Soluble Tapioca fibre syrup (FiberSMART ® | 21 | 65-80 |
| syrup/Promitor ® L70/Promitor ® 85/ | | |
| Nutriose ® 06/Nutriose ® 10) | | |
| Skim milk powder | 7 | — |
| Sodium chloride | 0.2 | — |
| Vanilla flavour | 0.2 | — |

The confectionery filling only comprised a minimal amount of sugar in the form of lactose in the milk powder and maltose and other sugars in some of the raw fibre ingredients and no sucrose at all was present in the confectionery filling.

The resulting chocolate product had a similar taste and mouthfeel profile to a chocolate product comprising a sucrose-based confectionery filling. Moreover, the confectionery filling was able to provide an equivalent texture and function as a sucrose-based and/or glucose-based confectionery filling.

### Example 2: Chocolate Product Having a Jelly Confectionery Filling

The ingredients for the jelly confectionery filling are detailed in Table 2 below.

TABLE 2

| | Wet Weight | % soluble |
|---|---|---|
| | % of | dietary |
| | ingredient in | fibre of |
| Ingredient | filling | ingredient |
| Water | −11.1 | — |
| Inulin (Orafti ® HIS/Orafti ® L90/Fructulose) | 13 | 85-90 |
| IMO (DP3 Vitafiber ™/IMO Vitafiber ™/IMO | 35 | 60-90 |
| HDP Oligosmart ®/IMO OligoSmart ®) | | |
| Soluble Tapioca fibre syrup (FiberSMART ® | 40 | 85-90 |
| syrup/Promitor ® L70/Promitor ® 85/ | | |
| Nutriose ® 06/Nutriose ® 10) | | |
| Polydextrose (Sta-lite ® L90) | 15 | 70-90 |
| Unipectine ™ PG 759 | 1.5 | — |
| Thin boiling starch | 5 | — |
| Citric acid (50% solution) | 1.1 | — |
| Trisodium citrate | 0.22 | — |
| Red colour solution | 0.35 | — |
| Strawberry flavour | 0.15 | — |

The confectionery filling only comprised a minimal amount of sugar in the form of maltose and other sugars in some of the raw fibre ingredients and no sucrose at all was present in the confectionery filling.

The resulting chocolate product had a similar taste and mouthfeel profile to a chocolate product comprising a sucrose-based confectionery filling. Moreover, the confectionery filling was able to provide an equivalent texture and function as a sucrose-based and/or glucose-based confectionery filling.

### Example 3: Chocolate Product Having a Nougat Confectionery Filling

The ingredients for the nougat confectionery filling are detailed in Table 3 below.

TABLE 3

| | Wet Weight | % soluble |
|---|---|---|
| | % of | dietary |
| | ingredient in | fibre of |
| Ingredient | filling | ingredient |
| Water | 2.6 | — |
| Inulin (Orafti ® HIS/Orafti ® L90/Fructulose) | 35 | 85-90 |
| IMO (DP3 Vitafiber ™/IMO Vitafiber ™/IMO | 42 | 60-90 |
| HDP Oligosmart ®/IMO OligoSmart ®) | | |
| Soluble Tapioca fibre syrup (FiberSMART ® | 17 | 65-80 |
| syrup/Promitor ® L70/Promitor ® 85/ | | |
| Nutriose ® 06/Nutriose ® 10) | | |
| egg albumin | 2 | — |
| Unipectine ™ PG 759 | 1.4 | — |

The confectionery filling only comprised a minimal amount of sugar in the form of maltose and other sugars in some of the raw fibre ingredients and no sucrose at all was present in the confectionery filling.

The resulting chocolate product had a similar taste and mouthfeel profile to a chocolate product comprising a sucrose-based confectionery filling. Moreover, the confectionery filling was able to provide an equivalent texture and function as a sucrose-based and/or glucose-based confectionery filling.

### Example 4: Chocolate Product Having a Marshmallow Confectionery Filling

The ingredients for the marshmallow confectionery filling are detailed in Table 4 below.

TABLE 4

| | Wet Weight | % soluble |
|---|---|---|
| | % of | dietary |
| | ingredient in | fibre of |
| Ingredient | filling | ingredient |
| Water | 2.6 | — |
| Inulin (Orafti ® HIS/Orafti ® L90/Fructulose) | 35 | 85-90 |
| IMO (DP3 Vitafiber ™/IMO Vitafiber ™/IMO | 42 | 60-90 |
| HDP Oligosmart ®/IMO OligoSmart ®) | | |
| Soluble Tapioca fibre syrup (FiberSMART ® | 17 | 65-80 |
| syrup/Promitor ® L70/Promitor ® 85/ | | |
| Nutriose ® 06/Nutriose ® 10) | | |
| egg albumin | 2 | — |
| Unipectine ™ PG 759 | 1.4 | — |

The confectionery filling only comprised a minimal amount of sugar in the form of maltose and other sugars in some of the raw fibre ingredients and no sucrose at all was present in the confectionery filling.

The resulting chocolate product had a similar taste and mouthfeel profile to a chocolate product comprising a sucrose-based confectionery filling. Moreover, the confectionery filling was able to provide an equivalent texture and function as a sucrose-based and/or glucose-based confectionery filling.

### Example 5: Chocolate Product Having a fudge confectionery filling

The ingredients for the fudge confectionery filling are detailed in Table 5 below.

TABLE 5

| | Wet Weight | % soluble |
|---|---|---|
| | % of | dietary |
| | ingredient in | fibre of |
| Ingredient | filling | ingredient |
| Water | −6.1 | — |
| canola oil | 4 | — |
| soya lecithin | 0.03 | — |
| Inulin (Orafti ® HIS/Orafti ® L90/Fructulose) | 14.7 | 85-90 |
| IMO (DP3 Vitafiber ™/IMO Vitafiber ™/IMO | 38 | 60-90 |
| HDP Oligosmart ®/IMO OligoSmart ® | | |
| Soluble fibre-liquid corn (PROMITOR ® 85NL, | 21 | 70-95 |
| Tate & Lyle/Promitor ® L70/Promitor ® 85/ | | |
| Nutriose ® 06/Nutriose ® 10) | | |
| Soluble Tapioca fibre syrup (FiberSMART ® | 21 | 65-80 |
| syrup/Promitor ® L70/Promitor ® 85/ | | |
| Nutriose ® 06/Nutriose ® 10) | | |
| Skim milk powder | 7 | — |
| Sodium chloride | 0.2 | — |
| Caramel flavour | 0.2 | — |

The confectionery filling only comprised a minimal amount of sugar in the form of lactose in the milk powder and maltose and other sugars in some of the raw fibre ingredients and no sucrose at all was present in the confectionery filling.

The resulting chocolate product had a similar taste and mouthfeel profile to a chocolate product comprising a sucrose-based confectionery filling. Moreover, the confectionery filling was able to provide an equivalent texture and function as a sucrose-based and/or glucose-based confectionery filling.

### Example 6: Chocolate Product Having a Honeycomb Confectionery Filling

The ingredients for the honeycomb confectionery filling are detailed in Table 6 below.

TABLE 6

| | Wet Weight | % soluble |
|---|---|---|
| | % of | dietary |
| | ingredient | fibre of |
| Ingredient | in filling | ingredient |
| Water | −6.1 | — |
| canola oil | 4 | — |
| soya lecithin | 0.03 | — |
| Inulin (Orafti ® HIS/Orafti ® L90/Fructulose) | 14.7 | 85-90 |
| IMO (DP3 Vitafiber ™/IMO Vitafiber ™/IMO | 38 | 60-90 |
| HDP Oligosmart ®/IMO OligoSmart ®) | | |
| Soluble fibre-liquid corn (PROMITOR ® 85NL, | 21 | 70-95 |
| Tate & Lyle/Promitor ® L70/Promitor ® 85/ | | |
| Nutriose ® 06/Nutriose ® 10) | | |
| Soluble Tapioca fibre syrup (FiberSMART ® | 21 | 65-80 |
| syrup/Promitor ® L70/Promitor ® 85/ | | |
| Nutriose ® 06/Nutriose ® 10) | | |
| Skim milk powder | 7 | — |
| Sodium chloride | 0 | — |
| Caramel flavour | 0.2 | — |
| bicarbonate of soda/potassium carbonate | 1.8 | — |

The confectionery filling only comprised a minimal amount of sugar in the form of lactose in the milk powder and maltose and other sugars in some of the raw fibre ingredients and no sucrose at all was present in the confectionery filling.

The resulting chocolate product had a similar taste and mouthfeel profile to a chocolate product comprising a sucrose-based confectionery filling. Moreover, the confectionery filling was able to provide an equivalent texture and function as a sucrose-based and/or glucose based confectionery filling. The above embodiments are described by way of example only.

Many variations are possible without departing from the scope of the invention as defined in the appended claims.

1. A chocolate product comprising a chocolate shell containing a confectionery filling wherein the shell comprises at least 15 wt. % of the product and wherein the filling comprises at least one soluble dietary fibre in an amount of at least 40 wt. % and wherein the filling comprises less than 35 wt. % sugar or sugars.

2. A chocolate product according to claim 1, wherein the at least one soluble dietary fibre is selected from the group consisting of inulin, fructooligosaccharide (FOS), isomaltose oligosaccharide (IMO), polydextrose, maltodextrin, vegetable-derived fibres, plant-derived fibres, galacto-oligosaccharide (GOS), levan, phlein, graminin, neo-levan, neo-inulin, hemicellulose, xylans, arabinoxylan, milk oligosaccharides, milk fibres, cellodextrins such as cellobiose and cellotriose, polydextrose, kestose, nystose, raffinose, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, 2′-fucosyl lactose, lacto-n-neotetraose, glucan (i.e., glucose containing) oligosaccharides, cello-oligosaccharides (or cellodextrins), resistant dextrins (e.g., soluble corn fibre, soluble pea fibre, soluble wheat fibre, soluble tapioca fibre), nigero-oligosaccharides, nigerotriose, nigerotetraose, kojitriose, kojitetraose, dextrans, beta glucans, lichenan, and isolichenan, and combinations thereof.

3. A chocolate product according to claim 1, wherein the confectionery filling comprises at least one fructan and at least one further soluble dietary fibre in a total amount of at least 40 wt. %.

4. A chocolate product according to claim 3, wherein the at least one fructan is selected from the group consisting of inulin, fructooligosaccharide (FOS), levan, phein, graminin, neo-levan, neo-inulin and combinations thereof.

5. A chocolate product according to claim 1, wherein the confectionery filling comprises at least one fructan; at least one IMO; and at least one further soluble dietary fibre.

6. A chocolate product according claim 5, wherein the confectionery filling comprises at least one fructan selected from the group consisting of inulin, FOS, and combinations thereof in an amount (or total amount) of from 2-85 wt. %, preferably from 10-35 wt. % of the confectionery filling.

7. A chocolate product according to claim 5, wherein the blend of confectionery filling comprises IMO in an amount of from 2-60 wt. %, preferably 25-35 wt. % of the confectionery filling

8. A chocolate product according to claim 5, wherein the confectionery filling comprises at least one further soluble dietary fibre selected from the group consisting of polydextrose, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, milk oligosaccharides, 2′-fucosyl lactose, lacto-n-neotetraose, glucan (i.e., glucose containing) oligosaccharides, cello-oligosaccharides (or cellodextrins), resistant dextrins (e.g., soluble corn fiber, soluble wheat fiber, soluble tapioca fiber, soluble pea fibre), nigero-oligosaccharides, nigerotriose, nigerotetraose, kojitriose, kojitetraose, dextrans, beta glucans, lichenan, isolichenan, and combinations thereof in a total amount of from 2-72 wt. %, preferably 10-45 wt. % of the confectionery filling.

9. A chocolate product according to claim 5, confectionery filling comprises at least one fructan selected from the group consisting of inulin, FOS, and combinations thereof in a total amount of from 2-72 wt. % of the confectionery filling; IMO in an amount of from 2-60 wt. % of the confectionery filling; and at least one further soluble dietary fibre selected from the group consisting of polydextrose, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, milk oligosaccharides, 2′-fucosyl lactose, lacto-n-neotetraose, glucan (i.e., glucose containing) oligosaccharides, cello-oligosaccharides (or cellodextrins), resistant dextrins (e.g., soluble corn fiber, soluble wheat fiber, soluble tapioca fiber, soluble pea fibre), nigero-oligosaccharides, nigerotriose, nigerotetraose, kojitriose, kojitetraose, dextrans, beta glucans, lichenan, isolichenan, and combinations thereof in an amount (or total amount) of from 2-50 wt. % of the confectionery filling.

10. A chocolate product according to claim 5, wherein the confectionery filling comprises at least one fructan in a total amount of from 10-35 wt. % of the confectionery filling; IMO in an amount of from 25-35 wt. % of the confectionery filling; and at least one further soluble dietary fibre in a total amount of from 10-45 wt. % of the confectionery filling.

11. A chocolate product according to claim 1, wherein the confectionery filling comprises less than 20, 15, 10, 5, 4, 3, 2, 1 or 0.5 wt. % sugars.

12. A chocolate product according to claim 1, wherein the confectionery filling comprises less than 5, 4, 3, 2, 1 or 0.5 wt. % sucrose and/or glucose.

13. A chocolate product according to claim 1, wherein the confectionery filling is essentially free from sucrose and/or glucose or is free from sucrose and/or glucose.

14. A chocolate product according to claim 1, wherein the confectionery filling is a caramel, nougat, marshmallow, fudge jelly or honeycomb.

15. A chocolate product according to claim 1, wherein the confectionery filling comprises less than 10 wt. % of sugar alcohols, preferably less than 5, 4, 3, 2, 1, 0.5 or less than 0.1 wt. % sugar alcohols.

16. A chocolate product according to claim 1, wherein the filling comprises less than 5wt. % sugar or sugars and less than 5wt. % sugar alcohols.

17. A chocolate product according to claim 1, wherein the confectionery filling is essentially free from sugar alcohols.

18. A chocolate product according to claim 1, wherein the confectionery filling is essentially free of a low energy sugar.

19. A chocolate product according to claim 1, wherein the chocolate shell comprises from 15-25 wt. % of the product.

20. A chocolate product according to claim 1, wherein the confectionery filling comprises 75-85 wt. % of the product.

21. A chocolate product according to claim 1, wherein the confectionery filling is partially or fully surrounded by the chocolate shell.

22. A chocolate product according to claim 21, wherein an outer surface of the confectionery filling is at least 50% surrounded by the chocolate shell, or preferably 100% of the outer surface area of the confectionery filling is surrounded by the chocolate shell.

23. A food product having a filling comprising the chocolate product according to claim 1.

24. A packaged chocolate product according to claim 1.

25. A method of preparing the chocolate product according to claim 1, the method comprising the steps of providing a chocolate shell and providing a confectionery filling, depositing the confectionery filling into the chocolate shell and optionally sealing the chocolate shell.

26. A method of preparing the chocolate product according to claim 1, the method comprising the steps of providing a chocolate shell and providing a confectionery filling, and coating the confectionery filling with the chocolate shell.

27. A method of providing a filled or coated food product, in which the food product is filled or coated with the chocolate product according to claim 1.
